(19) United States
(12) Patent Application Publication
(10) Pub. No.: US 2024/0018045 A1
(43) Pub. Date: Jan. 18, 2024

(54) PROCESS FOR THE PRODUCTION OF AN ULTRA-LIGHT MINERAL, AND USE OF THE RESULTING MINERAL FOAM AS A REFRACTORY MATERIAL

(71) Applicant: HOLCIM TECHNOLOGY LTD, ZUG (CH)

(72) Inventors: Patrick TINTILLIER, HOLDERBANK (CH); Sébastien GEORGES, HOLDERBANK (CH)

(21) Appl. No.: 18/253,872

(22) PCT Filed: Dec. 7, 2021
(86) PCT No.: PCT/EP2021/084648

§ 371 Date: May 22, 2023

(30) Foreign Application Priority Data
Dec. 7, 2020 (EP) 20306513.1

(51) Int. Cl. C04B 28/06; C04B 38/10; C04B 7/32

(52) U.S. Cl. CPC C04B 28/06; C04B 38/106; C04B 7/32; C04B 2111/00431

(57) ABSTRACT

A process for the production of a mineral foam suitable for its use as refractory material includes (i) separately preparing a slurry of cement and an aqueous foam, wherein the cement slurry comprises water (W), an aluminate cement (C) and a lithium salt; (ii) contacting the slurry of cement with the aqueous foam to obtain a slurry of foamed cement; (iii) adding lithium salt during or after stage (ii); (iv) casting the slurry of foamed cement and leaving it to set.

The present invention refers to a process for the production of an ultra-light mineral, and to the use of the resulting mineral foam as a refractory material.

A mineral foam is a material in the form of foam. This material is generally more lightweight than typical concrete due to its pores or empty spaces. These pores or empty spaces are due to the presence of air in the mineral foam which may be in the form of bubbles. An ultra-light mineral foam is understood to having a density in its dry state comprised between 20 and 2000 kg/m³, preferentially between 20 and 600 kg/m³, and even more preferentially between 20 and 300 kg/m³.

Generally, a mineral foam, in particular a mineral foam made from a cement, is highly advantageous for many applications due its excellent thermal insulation properties, its acoustic insulation properties, its durability, its resistance to fire and its easy preparation and casting.

One of the main technical difficulties related to the preparation of a mineral foam is its stability before the cement sets, resulting in the foam becoming hard. After the freshly prepared mineral foam is poured into an element, it may slump due to a lack of stability. This may be due to coalescence of the bubbles, to a phenomenon of Ostwald ripening, to hydrostatic pressure, or to draining phenomena.

Furthermore, for a mineral foam to be suitable as a refractory material, it needs to make use of specific cement types. Refractory materials are typically made from cements that contain high amounts of alumina and aluminate cements such as calcium aluminate cements or calcium sulfoaluminate cements are well known to be suitable for producing refractory materials. The difficulty related to the production of a mineral foam suitable for its use as a refractory material needs to be overcome when specific aluminate cements are used. More specifically, the cement needs to contain a minimum amount of alumina.

U.S. Ser. No. 10/160,691 discloses a mineral foam made from aluminate cements. However the process of preparation of the mineral foam disclosed is not suitable for a continuous production at industrial scale. WO2017085416, WO2017093795, WO2017093796 and WO2017093797 all disclose processes of production of mineral foams that makes use of Portland cement. The processes disclosed in these patent applications are continuous and suitable for large industrial scale production of ultra-light mineral foams, but are specific to Portland cements. These mineral foams do not have refractory properties, as Portland cement does not contain sufficient alumina.

The problem that the present invention intends to solve is to provide a process of preparation of a stable and ultra-light mineral foam suitable for its use a refractory material, the process relatively being effortlessly scaled to any industrial requirement.

The invention relates to a process for the production of a mineral foam suitable for its use as refractory material comprising the following steps:
(i) separately preparing a slurry of cement and an aqueous foam, wherein the cement slurry comprises water (W), an aluminate cement (C) and lithium salt;
(ii) contacting the slurry of cement with the aqueous foam to obtain a slurry of foamed cement;
(iii) adding lithium salt during or after step (ii);
(iv) casting the slurry of foamed cement and leaving it to set.

The terms “slurry of cement” and “cement slurry” have the same meaning and will be used interchangeably.

When the term “cement” is used in the present description, it refers, except mention to the contrary, to an aluminate cement. According to another feature of the invention, a mineral foam is obtained or obtainable by the inventive process. The foam according to the invention may be used as refractory material or insulating refractory material.

The process for production of a mineral foam according to the invention may be used in a discontinuous or continuous system.

The process provided by the present invention has one or more of the following characteristics:
the process is universal, which is to say it makes it possible to produce a stable mineral foam from any type of aluminate cement;
the process is easy to implement and to use at an industrial scale;
the process can be easily transported to any site;
the process makes it possible to implement a mineral foam in a continuous manner. It is therefore possible to produce the mineral foam continuously and to pour this foam without interruption.

The mineral foam provided by the instant invention has one or more of the following characteristics:
the mineral foam according to the invention has excellent stability properties. In particular, it is possible to obtain foam that does not slump or only very slightly when the foam is poured vertically or from a considerable height. For example, the mineral foam according to the invention did not slump or only very slightly when it is poured vertically from a height greater than or equal to 2 meters;
the high stability of the mineral foam makes the preparation of lightweight mineral foams possible;
the mineral foam according to the invention has excellent thermal properties, and in particular very low thermal conductivity. Furthermore, this decrease makes it possible to reduce thermal bridges;
the mineral foam according to the invention is a suitable refractory material as defined in the standard ASTM C71 of 2018, i.e. it is able to withstand high temperatures of above 1000° F. or 538° C. for long periods of time without any change to its physical and chemical properties.

The aluminate cement of the invention is a refractory cement. The aluminate cement of the invention preferentially comprises aluminium oxide and mullite, the sum of the weight percentages of aluminium oxide and mullite being comprised between 20 and 90% of the total weight of the cement.

The refractory cement compositions available on the market very often comprise formulation agents and thus contain, among other things, water-reducing plasticisers, setting accelerators such as lithium salts, and retarders, such as carboxylic or citric acid. Such formulated compositions may not be suitable for the present invention as, for example, their setting time can be too long resulting in the foam collapsing before it solidifies. The cement of the present invention preferentially contains less than 2% by weight, preferably less than 1% by weight, compared to the total weight of the cement, of calcium sulfate. The cement of the present invention preferentially does not contain any source of calcium sulfate. A source of calcium sulfate is a material that contains at least 50% by weight of calcium sulfate CaSO₄. Typical sources of calcium cement are natural or synthetic gypsum, anhydrite or hemi-hydrate.

The aluminate cement is preferably the sole cement of the mineral foam.

The water/cement (w/c) ratio (weight/weight ratio) of the cement slurry prepared in step (i) is preferably comprised between 0.10 and 0.25, more preferably between 0.13 and 0.20, and in particular 0.15. The water/cement ratio may vary, for example due to the water demand of the mineral particles in the cement slurry, in case these are used. The water/cement ratio is defined as being the ratio by weight of the quantity of water (W) to the cement weight (C).

The cement slurry prepared in step (i) may further comprise a water reducer, such as a plasticiser or a super-plasticiser. A water reducer makes it possible to reduce the amount of mixing water for a given workability by typically 10-15% by weight. By way of example of water reducers, mention may be made of lignosulphonates, hydroxycarboxylic acids, carbohydrates, and other specific organic compounds, for example glycerol, polyvinyl alcohol, sodium alumino-methyl-siliconate, sulfanilic acid and casein as described in the Concrete Admixtures Handbook, Properties Science and Technology, V. S. Ramachandran, Noyes Publications, 1984.

Super-plasticisers belong to a new class of water reducers and are capable of reducing water contents of mixing water, for a given workability, by approximately 30% by weight. By way of example of a super-plasticiser, the PCP super-plasticisers without an anti-foaming agent may be noted. The term “PCP” or “polyoxy polycarboxylate” is to be understood according to the present invention as a copolymer of acrylic acids or methacrylic acids and their esters of polyoxy ethylene (POE).

Preferably, the cement slurry does not comprise an anti-foaming agent, or any agent having the property of destabilizing an air/liquid emulsion. Certain commercial super-plasticisers may contain anti-foaming agents and consequently these super-plasticisers are not suitable for the cement slurry used to produce the mineral foam according to the invention.

The cement slurry used to produce the mineral foam according to the invention further comprises lithium salt, preferably in an amount between 0.05 and 1.5%, more preferably between 0.05 and 1%, more preferentially between 0.1 and 0.5%, the % are expressed as dry weight relative to the cement weight.

The lithium salt added during step (i) of the process are also hereafter referred to as “the first part of lithium salt”, since lithium salt is further added later in the process.

The process of the invention is original in that lithium salt, which is usually added to aluminate cement for preparing refractory cement composition, is not added one-shot to the cement slurry. On the contrary, at least one part of the total lithium salt content is added during step (iii) of the process of the invention.

According to an embodiment of the invention, other additives may be added to the cement slurry or the aqueous foam. Such additives may be thickening agents, viscosity modifying agents, air entraining agents, setting retarders, hollow glass beads, mineral additions or their mixtures. Preferably, the additives do not comprise any defoaming agents.

The expression “thickening agent”, is generally to be understood as any compound making it possible to maintain the heterogeneous physical phases in equilibrium or facilitate this equilibrium. The suitable thickening agents are preferably gums, cellulose or its derivatives, for example cellulose ethers or carboxy methyl cellulose, starch or its derivatives, gelatine, agar, carrageenans or bentonite clays.

The setting retarders can be selected among any known to retard the setting of calcium aluminate cements. Preferably, citric acid is used, at a dosage of less than 1% of the weight of cement.

According to an embodiment of the invention, the cement slurry used to produce the mineral foam according to the invention may further comprise mineral component. Preferably, the cement slurry used to produce the mineral foam according to the invention may comprise 5 to 90% of mineral component, preferably to 90% of mineral component, the percentages being expressed by weight relative to the weight of cement+mineral component. The suitable mineral components are selected from silica, silica fume, alumina, aluminosilicates including mullite and andalusite, zircon and zirconia, metakaolin, or mixtures thereof.

As mentioned previously, preferably the cement slurry does not comprise other cement than the aluminate cement. Preferably, if additional cement is present, meaning non-aluminate cement, its content is below 5%, the percentages being expressed by weight relative to the weight of cements+mineral component. Preferably the cement slurry does not comprise any source of calcium sulfate. Preferably, if source of calcium sulfate is present, the calcium sulfate content is below 5%, more preferably below 1%, the percentages being expressed by weight relative to the weight of cement+calcium sulfate+mineral component.

According to the invention, a lithium salt is added during or after step (ii), i.e. during or after contacting the cement slurry with the aqueous foam to obtain a slurry of foamed cement. The cement slurry already contains a first part of a lithium salt, as defined above. The lithium salt added during step (iii) is thus also called “second part of lithium salt”.

Preferably, the first part of lithium salt and the second part of lithium salt constitute the total lithium salt content. Accordingly, the process of the invention comprises the following steps:
(i) separately preparing a slurry of cement and an aqueous foam, wherein the cement slurry comprises water (W), an aluminate cement (C) and a first part of a lithium salt;
(ii) contacting the slurry of cement with the aqueous foam to obtain a slurry of foamed cement;
(iii) adding a second part of the lithium salt during or after step (ii);
(iv) casting the slurry of foamed cement and leaving it to set.

The second part of lithium salt is preferably added so as to obtain a preferable final total lithium salt dosage comprised between 0.05% and 2.5%, the % are expressed as dry weight relative to the cement weight.

The respective amounts of lithium salt added in step (i) and step (iii) may be adjusted to the specific reactivity of the cement, or to parameters such as the temperature or the production rate. Preferably, between 10% and 90% by weight, preferentially between 10% and 60% by weight, even more preferentially between 10% and 40% of the total amount of lithium salt is added in step (i).

The lithium salt is effective as an accelerator that accelerates that setting of the slurry of foamed cement. The lithium salt dosage is low. The lithium salt has long-lasting effects. In particular, the use of a lithium salt specifically stabilizes mineral foams that make use of refractory cement and limits water drainage in the foam before the slurry of foamed cement sets. The addition of lithium salts in several parts, preferably in two parts, allows the manufacturing of highly stable ultra-low density mineral foams, and this independent of the type of aluminate cement used. The quality of the foam is improved.

It has been observed that the addition of lithium salt in several parts, preferably in two parts, i.e. during the preparation of the cement slurry, and during or after the preparation of the slurry of foamed cement is highly advantageous. If all of the lithium salt is added to the cement slurry in step (i), the slurry will set too quickly and will render the production process highly susceptible to issues such as material build up and blockages in the mixer. If all the lithium salt is added during or after step (ii), the high amount of water added at that moment of the process would result in the destabilisation of the slurry of foamed cement coming out of the mixing device. This high amount of water is due to the relative low solubility of lithium salts in water.

Preferably, in step (iii), an aqueous solution comprising the lithium salt is added.

Preferably, step (iii) is performed during step (ii). Accordingly, the lithium salt is added to the aqueous foam. Preferably, step (iii) is performed after step (ii). Accordingly, the lithium salt is added to the slurry of foamed cement.

In both cases, step (iii) is performed before step (iv). Preferably, the lithium salt is lithium carbonate, lithium sulfate, lithium hydroxide, or mixtures thereof. Even more preferably, the lithium salt is lithium carbonate.

The process of the invention overcomes the technical prejudice according to which the use of various additives is necessary in order to ensure the stability of the mineral foam.

In particular, the mineral foam obtained by the invention is substantially free of calcium sulfate and fine particles. The term “fine particles” is understood to comprise particles, the mean diameter D50 of which is below 2 μm. The D50 diameter corresponds to the 50^{th} percentile of the distribution by volume of the particle size, i.e. 50% of the volume is formed by particles having a size that is below the D50 diameter and 50% having a size that is above the D50 diameter. The term “substantially” means less than 5%, preferably less than 1%, more preferably less than 0.5% expressed in weight in relation to the cement weight.

In step (i), the slurry may be prepared using mixers typically used to produce cement slurries. They may be a mixer for slurries, a mixer from a cement batching plant, a mixer described in the European NF EN 196-1 Standard of April 2006—Paragraph 4.4, or a beater with a planetary movement.

According to a first mode of operation, the cement slurry may be prepared by introducing into a mixer water and optionally additives (such as a water reducer). Thereafter, the aluminate cement, and optionally other pulverulent components, is added into the mixer. The paste that is obtained in this way is then mixed for obtaining the cement slurry. Preferably, the cement slurry is kept under agitation for example by means of a deflocculating paddle at a speed which may be between 1000 and 600 rpm, depending on the volume of the slurry, during the entire manufacturing process.

According to a second mode of operation, the cement slurry may be prepared by introducing a part of the water and optionally the additives (such as a water reducer) in a mixer, and then the aluminate cement and afterwards the further components. According to a third mode of operation, the cement slurry may be prepared by introducing into a mixer the aluminate cement, and eventually all the others pulverulent components. The aluminate cement and the pulverulent components are mixed in order to obtain a homogenous mixture. Water and optionally the additives (such as a water reducer) are then introduced into the mixer.

According to a fourth mode of operation, the cement slurry is prepared in a continuous way by preparing in advance a mixture containing the cement, water and additives (such as a water reducer).

In step (i), the aqueous foam may be produced by combining water and a foaming agent, then introducing a gas. This gas is preferably air. The foaming agent is preferably used in an amount of 0.25-5.00 wt.-%, preferably 0.75-2.50 wt.-%, (dry weight) of the weight of water.

The slurry of foamed cement may optionally comprise a co-stabiliser. The co-stabiliser is advantageously added in the aqueous foam, in particular in the aqueous solution comprising the foaming agent.

The introduction of air may be carried out by stirring, by bubbling or by injection under pressure. Preferably, the aqueous foam may be produced using a turbulent foamer (bed of glass beads for example). This type of foamer makes it possible to introduce air under pressure into an aqueous solution comprising a foaming agent.

The aqueous foam may be generated continuously in the process according to the invention.

The generated aqueous foam has air bubbles with a D50, which is less than or equal to 400 μm, preferably comprised from 100 to 400 μm, more preferably comprised from 150 to 300 μm. Preferably, the generated aqueous foam has air bubbles with a D50 which is 250 μm.

The D50 of the bubbles is measured by back scattering. The apparatus used is the Turbiscan® Online provided by the Formulaction company. Measurements of the back scattering make it possible to estimate a D50 for the bubbles of an aqueous foam, by knowing beforehand the volume fraction of the bubbles and the refractive index of the solution of foaming agent. Preferably, the foaming agent is an organic protein derivative of animal origin (such as, e.g., the foaming agent named Propump26, a powder of hydrolysed keratin, sold by the company Propump Engineering Ltd) or of vegetable origin. The foaming agents may also be a cationic surfactant (for example cetyltrimethylammonium bromide, CTAB), an ionic surfactant, an amphoteric surfactant (for example cocamidopropyl betaine, CAPB), or a nonionic surfactant, or mixtures thereof.

The co-stabiliser according to the invention is not a water-reducer or a high water-reducer, and thus is not a plasticiser or a superplasticiser.

In the context of the present invention, a “water-reducer” or a “plasticiser” is an agent which, in accordance with standard ADJUVANT NF EN 934-2 (September 2002), allows a water reduction for admixed concrete ≥5% relative to control concrete. A “high water-reducing agent” or “superplasticiser” is an admixture which allows a water reduction for admixed concrete ≥12% relative to control concrete.

The co-stabiliser according to the invention does not correspond to these characteristics.

The co-stabiliser is preferably a polyelectrolyte, in particular a polyanion.

The co-stabiliser is preferentially a polymer having constitutional unit derived from unsaturated carboxylic acid monomer or anhydride thereof. The carboxylic acid monomer can be monocarboxylic acid monomer or dicarboxylic acid monomer. Examples thereof include:
acrylic acid, methacrylic acid; crotonic acid, maleic acid, fumaric acid, itaconic acid, and citraconic acid, and their monovalent metal salts, divalent metal salts, ammonium salts, and organic amine salts, and anhydride thereof;
esters, half esters and diesters of the above-mentioned unsaturated carboxylic acid monomers with alcohols having 1 to 12 carbon atoms, with alkoxy (poly)alkylene glycols, in particular with alkoxy (poly)ethylene glycol or with alkoxy (poly)propylene glycol;
amides, half amides and diamides of the above-mentioned unsaturated carboxylic acid monomers with amines having 1 to 30 carbon atoms, such as methyl(meth)acrylamide, (meth)acrylalkylamide, N-methylol(meth)acrylamide, and N,N-dimethyl(meth)acrylamide;
alkanediol of the above-mentioned unsaturated carboxylic acid monomers such as 1,4-butanediol mono(meth)acrylate, 1,5-pentanediol mono(meth)acrylate, and 1,6-hexanediol mono(meth)acrylate;
amines of the above-mentioned unsaturated carboxylic acid monomers such as aminoethyl (meth)acrylate, methylaminoethyl (meth)acrylate, dimethylaminoethyl (meth)acrylate, dimethylaminopropyl (meth)acrylate, and dibutylaminoethyl (meth)acrylate.

These monomers may be used either alone respectively or in combinations of two or more thereof. The monomer is in particular selected from acrylic acid, methacrylic acid, crotonic acid, maleic acid, fumaric acid, itaconic acid, and citraconic acid and anhydride thereof, in particular maleic anhydride, and mixtures thereof.

These monomers can also be copolymerised with hydrophobic monomers, in particular with:
vinyl aromatic monomers such as styrene, alpha methylstyrene, vinyltoluene, and p-methylstyrene;
dienes such as butadiene, isoprene, 2-methyl-1,3-butadiene, and 2-chloro-1,3-butadiene;
1-alkenyl monomers having 2 to 12 carbon atoms, such as di-isobutylene.

The co-stabiliser is preferentially a copolymer of the above-mentioned unsaturated carboxylic acid monomers, or anhydride thereof, and of 1-alkenyl monomers having 2 to 12 carbon atoms, such as di-isobutylene. In particular the co-stabiliser is a copolymer of maleic anhydride and di-isobutylene.

The acid carboxylic function of the polymer is preferably totally or partially in a salt form. Advantageously the salt is a cation chosen from among the sodium, potassium, calcium, magnesium, ammonium, or their blends, preferentially chosen from among sodium or potassium and very preferentially sodium. In a preferred embodiment, the co-stabiliser is a sodium salt of a maleic anhydride copolymer, in particular a sodium salt of a maleic anhydride and di-isobutylene copolymer. A commercial product commercialised by Dow, TAMOL 731 A, was found to be suitable for this invention.

In step (ii), the cement slurry may be homogenized with the aqueous foam by any means to obtain a slurry of foamed cement.

Preferably, step (ii) of the process according to the invention may comprise the introduction of the cement slurry and the aqueous foam into a static mixer to obtain a slurry of foamed cement.

The suitable static mixers preferably have elements in the form of a propeller to ensure complete radial mixing and successive divisions of the flow for each combination of liquids and gas. The suitable static mixers according to the invention preferably have helical elements which transmit a radial speed to the fluid, which is directed alternatively towards the side of the mixer, then towards its centre. The successive combinations of elements directing the flow clockwise and counter clockwise provoke a change of direction and a division of the flow. These two combined actions increase the efficiency of the mixing. Preferably, the static mixer used in the process according to the invention is a mixer operating by dividing the continuous flow of cement slurry and of aqueous foam. The homogeneity of the mix is based on the number of divisions. According to the process of the invention, 16 elements are preferably used to ensure good homogeneity. The suitable static mixers according to the process of the invention are preferably those commercialised under the brand name of Kenics®.

According to a more particular embodiment, the cement slurry is pumped at a precise volume flow, which is a function of the target composition of foamed cement slurry. Then, this cement slurry is combined with the aqueous foam already circulating in the circuit of the process. The slurry of foamed cement according to the invention is thus generated. This slurry of foamed cement is cast and left to set.

Advantageously, the inventive process does not need neither an autoclave step, nor a thermal treatment step (for example at 60-80° C.) in order to obtain a mineral foam according to the invention.

The invention also relates to a slurry of foamed cement as obtained in step (ii) of the process of the invention.

Further, the invention also relates to a mineral foam obtained according to the process of the invention.

Further, the invention also relates to a mineral foam obtainable according to the process of the invention.

The mineral foam of the invention may be prefabricated. The mineral foam according to the invention may also be directly prepared on the jobsite by installing a foaming system on the jobsite.

Preferably, the mineral foam according to the invention comprises 0.05-2.5% in weight of dry lithium salt by weight of cement, preferably 0.1-2.0% in weight of dry lithium salt by weight of cement.

Preferably, the mineral foam according to the invention may have a density of 20 to 2000 kg/m³, preferably from 20 to 600 kg/m³, and even more preferably from 20 to 300 kg/m³. It is to be noted that the density of the slurry of foamed cement (humid density) is different to the density of the mineral foam (density of the hardened material).

The mineral foam according to the invention has excellent refractory properties as defined in the standard ASTM C71 of 2018. This means that once hardened, the mineral foam is able to withstand high temperatures of above 1000° F. or 538° C. for long periods of time without any change to its physical and chemical properties. This means that the mineral foam does not crack, nor does its volume change as a consequence of its exposure to high temperatures. Such refractory properties make the mineral foam suitable for industries such as aluminum manufacturing, iron and steel manufacturing, cement manufacturing, copper manufacturing, electrical energy production, or titanium manufacturing.

The mineral foam may be used for its refractory properties as is or as a component of a system. Such a system may for example further comprise refractory bricks.

The invention provides another advantage in that the mineral foam according to the invention has excellent thermal properties, and in particular very low thermal conductivity. Thermal conductivity (also called lambda (A)) is a physical value characterizing the behaviour of materials during the transfer of heat by conduction. Thermal conductivity represents the quantity of heat transferred per unit of surface and per unit of time submitted to a gradient of temperature. In the international system of units, thermal conductivity is expressed in watts per metre Kelvin (W/m·K). Typical or conventional concretes have thermal conductivity values measured at 23° C. and 50% relative humidity of 1.3 to 2.1. The thermal conductivity of the mineral foam according to the invention with a dry density of 70 kg/m³ may be from 0.030 to W/m·K, preferably from 0.030 to 0.060 W/m·K, more preferably from 0.030 to 0.055 W/m·K, the margin of error being ±0.4 mW/m·K.

The invention provides another advantage in that the mineral foam according to the invention has good mechanical properties, and in particular good compressive strength compared to known mineral foams. The compressive strength of the mineral foam according to the invention is from 0.1 to 15 MPa, preferably from 0.1 to 10 MPa, more preferably from 0.2 to 8 MPa.

The invention also relates to an element of construction comprising the mineral foam according to the invention.

The invention also relates to the use of the mineral foam according to the invention as construction material.

The mineral foam according to the invention may be used to cast walls, ceilings and roofs of a refractory system. It is also possible to realize prefabricated elements in a prefabrication plant, such as blocs or panels.

The invention also relates to the use of the mineral foam according to the invention as insulating material.

Advantageously, the mineral foam according to the invention may be used to fill empty or hollow spaces, a wall, a partition wall, a brick, a floor or a ceiling. In this case, it is used as a filling compound. Such composite construction elements also constitute objects of the invention per se.

Advantageously, the mineral foam according to the invention may be used as facade lining to insulate a building from the outside. In this case, the mineral foam according to the invention may be coated by a finishing compound.

The invention also relates to a system comprising the mineral foam according to the invention. The mineral foam may be present in the system, for example as insulating material. The system according to the invention is a system capable of resisting to transfers of air.

The system according to the invention may be used to produce a lining, an insulation system or a partition wall, for example a separation partition wall, a distribution partition wall or an inner partition.

The mineral foam according to the invention may be used to fill hollow parts of building blocks, such as cavity bricks. The foam may be filled into the cavity at any production step of the building bloc.

The mineral foam according to the invention may be cast vertically between two walls, for example between two concrete walls or two brick walls to obtain a system.

The invention will now be described by reference to the following non limitative examples.

The measuring methods used in the examples are now detailed below.

Laser Granulometry Method

In this specification, including the accompanying claims, particle size distributions and particle sizes are as measured using a laser granulometer of the type Mastersize 2000 (year 2008, series MAL1020429) sold by the company Malvern.

Measurement is effected in an appropriate medium (for example an aqueous medium for non-reactive particles, or alcohol for reactive material) in order to disperse the particles. The particle size shall be in the range of 1 μm to 2 mm. The light source consists of a red He—Ne laser (632 nm) and a blue diode (466 nm). The optical model is that of Frauenhofer and the calculation matrix is of the polydisperse type. A background noise measurement is effected with a pump speed of 2000 rpm, a stirrer speed of 800 rpm and a noise measurement for 10 s, in absence of ultrasound. It is verified that the luminous intensity of the laser is at least equal to 80% and that an decreasing exponential curve is obtained for the background noise. If this is not the case, the cell's lenses have to be cleaned.

Subsequently, a first measurement is performed on the sample with the following parameters: pump speed 2000 rpm and stirrer speed 800 rpm. The sample is introduced in order to establish an obscuration between 10 and 20%. After stabilisation of the obscuration, the measurement is effected with a duration between the immersion and the measurement being fixed to 10 s. The duration of the measurement is 30 s (30000 analysed diffraction images). In the obtained granulogram one has to take into account that a portion of the powder may be agglomerated. Subsequently, a second measurement is effected (without emptying the receptacle) with ultrasound. The pump speed is set to 2500 rpm, the stirrer speed is set to 1000 rpm, the ultrasound is emitted at 100% (30 watts). This setting is maintained for 3 minutes, afterwards the initial settings are resumed: pump speed at 2000 rpm, stirrer speed at 800 rpm, no ultrasound. At the end of 10 s (for possible air bubbles to clear), a measurement is carried out for 30 s (30000 analysed images). This second measurement corresponds to a powder desagglomerated by an ultrasonic dispersion.

Each measurement is repeated at least twice to verify the stability of the result.

Measurement of the Specific BLAINE Surface

The specific surface of the various materials is measured as follows. The Blaine method is used at a temperature of 20° C. with a relative humidity not exceeding 65%, wherein a Blaine apparatus Euromatest Sintco conforming to the European Standard E N 196-6 is used.

Prior to the measurement the humid samples are dried in a drying chamber to obtain a constant weight at a temperature of 50-150° C. The dried product is then ground in order to obtain a powder having a maximum particle size of less than or equal to 80 μm.

Measurement of Bulk Density and Apparent Porosity

Bulk density and apparent porosity are measured following the protocol given in ASTM C20 (2015).

Measurement of Thermal Conductivity

Thermal conductivity is measured following the protocol given in ASTM C1113 (2019).

Cold Crushing Strength

Cold crushing strength is measured following the protocol given in ASTM C133 (2015).

### EXAMPLES

Materials

A laboratory formulation of a mineral binder, hereafter called refractory binder, was used, with the following composition:

| | |
|---|---|
| Refractory aggregate - Mullite (Max size 5 mm) | 50 wt.-% |
| Calcium aluminate cement (SECAR71 from Imerys) | 10 wt.-% |
| Silica fume | 15 wt.-% |
| Corundum (Max size 5 mm) | 25 wt.-% |

The aluminium oxide content is around 70 wt.-% in SECAR 71 and around 100 wt.-% in corundum.

The salt added to stabilise the mineral foam is lithium carbonate, which was used as a powder of at least 99 wt.-% purity supplied by the company Sigma-Aldrich.

The foaming agent used is MAPEAIR L/LA supplied by the company MAPEI, having a solids content of 26 wt.-%.

Tap water was used in all of the examples.

Equipment

The Rayneri mixer:
A Turbotest mixer (MEXP-101, model: Turbotest 33/300, Serial No.: 123861) supplied by the company Rayneri, which is a mixer with a vertical axis.

Pumps:
A pump having an eccentric screw conveyer Seepex™ of the type MD 006-24, commission no. 244920.
A pump having an eccentric screw conveyer Seepex™ of the type MD 006-24, commission no. 278702.

Foamer:
A foamer comprising a bed of glass beads of the type SB30 having a diameter of 0.8-2.5 mm filled up in a tube having a length of 100 mm and a diameter of 12 mm.

Static Mixer:
A static mixer comprised of 32 helicoidal elements of the type Kenics having a diameter of 19 mm and referred to as 16La632 at ISOJET.

Preparation of Cement Slurry

For preparing one liter of slurry having a water/cement ratio of 0.15, the following composition was used:

TABLE 1

| | |
|---|---|
| Amount | Weight percentage wt.-% |

| | | | |
|---|---|---|---|
| Refractory binder | 2112.4 | g | 86.83 |
| Lithium carbonate | 3.6 | g | 0.148 |
| Tap water | 316.9 | g | 13.03 |
| Total | 2432.9 | g | 100 |

The cement slurry has been prepared by using the mixer Rayneri Turbotest 33/300, into which tap water has first been introduced. While mixing at 1000 rpm, the solid components have progressively been added. The cement slurry was then mixed for two additional minutes.

Preparation of the Foaming Solution

A foaming solution, i.e. an aqueous solution containing the foaming agents, was prepared using the following amounts of materials.

For one litre of foaming solution:

| | | |
|---|---|---|
| MAPEAIR L/LA | 25 | g |
| TAMOL 731 A (from DOW) | 2 | g |
| Tap water | 973 | g |

The foaming solution was pumped by means of a volumetric pump having an eccentric screw conveyor Seed TM MD-006-24 (commission no: 278702).

This foaming solution was introduced into the foamer through the bed of beads by means of pressurized air (1-6 bar) and a T-junction. The aqueous foam was produced in a continuous way at a rate of 8 litres per minute, having a density of 45 kg/m³.

Lithium Carbonate Salt

Lithium carbonate in powder form provided by Sigma Aldrich was used, with a purity of at least 99 wt.-%.

The salt was used to prepare an aqueous solution with a concentration of 1.67 g of lithium carbonate per 100 g of solution.

Preparation of the Fresh Mineral Foam

The aqueous foam as previously obtained, was brought into contact with the cement slurry each other in a static mixer and a slurry of foamed cement was obtained. The flow rate of the aqueous foam into the static mixer is of 377 g per minute.

The slurry rate is adjusted to obtain the target density of 500 kg/m³.

TABLE 2

| | | | |
|---|---|---|---|
| Targeted dry foam density (kg/m³) | 400 | 500 | 600 |
| Calculated wet density (kg/m³) | 442 | 540 | 640 |
| Flow rate of aqueous foam (g/min) | 377 | 370 | 377 |
| Slurry flow (g/min) | 3714 | 3992 | 4259 |

The aqueous solution of lithium carbonate was injected at a position located at two thirds of the length of the static mixer at a rate of 20 g per minute.

Preparation of Mineral Foam Cubes

The slurry of foamed cement was poured into cubes made of polystyrene having a dimension of 10×10×10 cm. Three cubes have been prepared for each slurry of foamed cement. The cubes have been demoulded after 1 day and stored 7 days at a relative humidity of 100% and a temperature of 20° C. The cubes were then dried at a temperature of 45° C. until a constant weight is obtained.

Analysis of the Mineral Foams

The stability of the foams has been measured by visual inspection of the cubes before demoulding. A foam has been described as “stable”, if the cube kept its height of 10 cm after setting. A foam has been described as “unstable”, if the cube has slumped during its setting. Each test was carried out on 3 cubes of 10×10×10 cm. The results show a similar performance among the 3 cubes. As the case may be, the results are the mean value of 3 cubes.

A column has been considered stable if the density between the lower section and the upper section does not differ by more than 5 kg/m³.

Refractory Properties of the Mineral Foam

The refractory properties of the foams are reported in the table below.

TABLE 3

| | | English units | | Metric units | |
|---|---|---|---|---|---|
| Bulk density | | 23.7 | lbs/ft³ | 378 | kg/m³ |
| Maximum service temperature | | 2200 | ° F. | 1200 | ° C. |
| Thermal | 73° F./23° C. | 0.81 | BTU- | 0.12 | W/m- |
| conductivity | 750° F./399° C. | 1.14 | in/hr- | 0.16 | K |
| | 1469° F./799° C. | 2.26 | ft² | 0.33 | |
| | 2188° F./1198° C. | 4.34 | | 0.62 | |
| | 2694° F./1479° C. | 6.82 | | 0.98 | |
| Cold | 450° F./232° C. | 39 | PSI | 0.3 | MPa |
| crushing | 700° F./371° C. | 31 | | 0.2 | |
| strength | | | | | |

| | | |
|---|---|---|
| Apparent porosity | 84.8 | % |

1. A method for the production of a mineral foam suitable for its use as refractory material comprising the following steps:
(i) separately preparing a slurry of cement and an aqueous foam, wherein the cement slurry comprises water (W), an aluminate cement (C) and a first part of lithium salt;
(ii) contacting the slurry of cement with the aqueous foam to obtain a slurry of foamed cement;
(iii) adding a second part of lithium salt during or after step (ii);
(iv) casting the slurry of foamed cement and leaving it to set.

2. The method according to claim 1, wherein the aluminate cement comprises aluminium oxide and mullite.

3. The method according to claim 1, wherein the aluminate cement does not contain a source of calcium sulfate.

4. The method according to claim 1, wherein the amount of lithium salt added in step (i) is comprised between 0.05 and 1.5% in weight of dry lithium salt by weight of cement.

5. The method according to claim 1, wherein in step (iii) an aqueous solution comprising the lithium salt is added.

6. The method according to claim 1, wherein step (iii) is performed after step (ii) and before step (iv).

7. The method according to claim 1, wherein the total amount of lithium salt is added in an amount of 0.05-2.5% in weight of dry lithium salt by weight of cement.

8. The method according to claim 1, wherein the lithium salt is lithium carbonate, lithium sulfate, lithium hydroxide, or mixtures thereof.

9. The method according to claim 1, wherein the aqueous foam prepared in step (i) have bubbles and the D50 of the bubbles is less than or equal to 400 μm.

10. The method according to claim 1, wherein the cement slurry in step (i) has a water/cement ratio (weight/weight ratio) comprised between 0.1 and 0.25.

11. The method according to claim 1, wherein the cement slurry comprises a water reducer.

12. The method according to claim 1, wherein the slurry of foamed cement comprises a retarder.

13. The method according to claim 1, wherein the cement slurry comprises at least one supplementary mineral component.

14. A mineral foam obtained or obtainable according to the process of claim 1, comprising 0.05-2.5% in weight of dry lithium salt by weight of cement.

15. The mineral foam obtained or obtainable according to claim 14 having a density comprised between 20 and 2000 kg/m³.

16. A method comprising utilizing the mineral foam according to claim 14 as a refractory material.

17. An element of a refractory system comprising the mineral foam according to claim 14.

18. The method according to claim 2, wherein the sum of the weight percentages of aluminium oxide and mullite is comprised between 20 and 90% by weight relative to the total cement weight.

19. The method according to claim 4, wherein the amount of lithium salt added in step (i) is comprised between 0.1 and 1.0%, the percentages are expressed in weight of dry lithium salt relative to the weight of cement.

20. The method according to claim 7, wherein the total amount of lithium salt is added in an amount of 0.1-2.0% in weight of dry lithium salt by weight of cement.

21. The method according to claim 13, wherein the supplementary mineral component is selected from silica, silica fume, alumina, aluminosilicates including mullite and andalusite, zircon and zirconia, metakaolin, or mixtures thereof.
